(19) United States
(12) Patent Application Publication
(10) Pub. No.: US 2008/0051173 A1
(43) Pub. Date: Feb. 28, 2008

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/598,626

(22) Filed: Nov. 14, 2006

Related U.S. Application Data
(60) Provisional application No. 60/839,676, filed on Aug. 24, 2006.

(51) Int. Cl. G07F 1/02

(52) U.S. Cl. 463/20

(57) ABSTRACT

In a unit game in which a base game is being executed, a stop control game is executed when a combination of the symbol “LOBSTER”s has come to a stop. In the stop control game, symbols being scrolled on a reel can be stopped by pressing a stop switch. Then, the number of activated winning combinations is increased if a symbol “OCTOPUS” comes to a stop when a player presses the stop switch to stop the symbols displayed on the reel. For example, two winning combinations are newly activated, in addition to the four initially activated winning combinations, whereby a total of six winning combinations are activated. Subsequently, payout of coins occurs when the activated winning combination has come to a stop on a payline.

### CROSS-REFERENCE TO RELATED APPLICATION

This application is based upon and claims the benefit of U.S. Provisional Patent Application Ser. No. 60/839,676, filed on Aug. 24, 2006; the entire contents of which are incorporated herein by reference for all purposes.

### BACKGROUND OF THE INVENTION

1. Field of the Invention

The present invention relates to a slot machine for playing a game using game media such as coins or bills, and a playing method thereof.

2. Description of Related Art

With conventional slot machines, such as those disclosed in United States patents U.S. Pat. No. 6,960,133B1 or U.S. Pat. No. 6,012,983, a plurality of symbols starts to be scrolled on a display unit provided in front of a cabinet when the player inserts game media such as tokens, coins or bills into the insertion slot of the slot machine and presses the spin button. Subsequently, respective symbols automatically come to a stop. At this time, symbols to be stopped is determined at the start of scrolling respective symbols, which is triggered by pressing the spin button. With winning a bonus game such as a mystery bonus or the second game after this determining process of the symbols to be stopped, transition from the base game to the bonus game occurs and the bonus game is executed.

Here, the slot machine is configured to payout a predetermined award when a winning combination occurs during execution of the game.

With such a slot machine as this, the symbols being scrolled merely stop automatically.

### SUMMARY OF THE INVENTION

The slot machine according to the first aspect of the present invention comprises a controller. The controller varies activated winning combinations of the symbols in the display area of the display, if a symbol arranged in another display area which is different from the display area turns out to be a specific symbol at the timing of rearrangement by accepting a control input signal from an external, when automatically rearranging a plurality of symbols which have been arranged in the display area of the display.

With the slot machine of the first aspect of the present invention, when the symbol has been rearranged in another display area by accepting a control input signal from an external and the rearranged symbol turns out to be a specific symbol, the controller executes a control to vary activated winning combinations The symbol to be rearranged is rearranged by coming to a stop from a scrolled state at an input timing of a control signal from an external, for example. This provides the player with privilege to rearrange the symbol. Therefore, with the present invention, various forms of display up to the rearrangement of the symbol can be employed other than the above-mentioned scrolling. The above-mentioned specific symbol can be the target of rearrangement from their display form based on the player's intention. Then, if rearrangement at the specific symbol succeeds, the controller executes a control to vary activated winning combinations. As for varying the activated winning combinations, variation such as increase of number of the activated winning combinations in case of a success in rearranging a specific symbol at another display area may be employed, which will be described below. Alternatively, it may also be employed that an activated winning combination associated with usual payout is changed to another activated winning combination associated with different payout in case of a success in rearranging a specific symbol at another display area. Alternatively, an activated winning combination which has corresponded with number of success times preliminarily may be automatically selected depending on the number of success times a specific symbol has been successfully rearranged at another display area.

The slot machine according to the second aspect of the present invention comprises a controller. During execution of the unit game for automatically rearranging a plurality of symbols which have been arranged in a display area of a display, the controller allows rearrangement of a symbol which have been arranged in another display area which is different from the display area by accepting a control input signal from an external. The controller varies the activated winning combinations of the symbols in the display area of the display, if the symbol rearranged in the other display area by accepting the control input signal from an external, turns out to be a specific symbol.

With the slot machine of the second aspect of the present invention, when the symbol has been rearranged in another display area by accepting the control input signal from an external in the unit game, the controller executes a control to vary activated winning combinations, if the symbol rearranged in the other display area turns out to be the specific symbol.

The slot machine according to the third aspect of the present invention comprises a display having a display area for arranging a symbol matrix formed by a plurality of columns and a plurality of rows, an arrangement controller, a stop switch, a stop switch controller, and a payline controller. The arrangement controller, in order to rearrange a plurality of symbols which have been arranged in the display area of the display as a new symbol matrix after scrolling the plurality of symbols, selects and determines symbols to be arranged into the symbol matrix from a plurality of types of symbols, and executes an arrangement control to stop the scrolling state at the arrangement of the determined symbols. The stop switch, connected to the arrangement controller, is a player-operable switch. There are occasions such that the symbol which have been arranged in another display area which is different from the display area may be rearranged during the scrolling for rearrangement into the new symbol matrix in the display area of the display. In such occasions the stop switch controller activates the stop switch when rearranging the symbol in the other display area and executes rearrangement of the symbol in the other display area in accordance with the player's input timing of the stop switch. The winning combination controller increases the number of activated winning combinations formed by the rearranged symbol matrix in the case of rearranging the symbol matrix being scrolled, if a specific symbol has been rearranged in the other display area.

With the slot machine of the third aspect of the present invention, when the symbols are scrolled in another display area and the scrolled symbols are rearranged by operating the stop switch, the winning combination controller executes a control to increase the number of activated winning combinations, if the rearranged symbol turns out to be a specific symbol.

The playing method of the slot machine according to the fourth aspect of the present invention, when the controller automatically rearranges a plurality of symbols which have been arranged in the display area of a display, the controller varies activated winning combinations of the symbols in the display area of the display, if the symbol which has been arranged in another display area which is different from the display area has been rearranged by accepting a control input signal from an external turns out to be a specific symbol.

With the playing method of a slot machine of the fourth aspect of the present invention, when the symbol are rearranged in another display area by accepting a control input signal from an external, the controller executes a control to vary activated winning combinations, if the rearranged symbol turns out to be a specific symbol.

The playing method executed by the slot machine according to the fifth aspect of the present invention comprises the following steps. A step in which when a plurality of symbols have been arranged in a display area of a display to be later rearranged thereon, the controller determines a plurality of symbols for rearrangement prior to their rearrangement to rearrange a combination of the symbols in the display area of the display. A step in which in a case in which a symbol arranged in another display area which is different from the display area is allowed to be rearranged until the combination of the symbols arranged in the display area is rearranged, when rearrangement is allowed, a stop switch connected to the controller is activated to rearrange the symbol in the other display area by an input from the stop switch, regardless of the control executed by the controller. And a step in which the number of activated winning combinations of the display area of the display is increased when the symbol rearranged in the other display area turns out to be a specific symbol.

With the playing method executed by the slot machine of the fifth aspect of the present invention, operation of the stop switch is activated when rearrangement of the symbol in another display area is allowed, whereby rearrangement of the symbol is allowed at the timing of operating the stop switch. Then, the number of activated winning combinations is increased if the rearranged symbol turns out to be a specific symbol.

The playing method executed by the slot machine according to the sixth aspect of the present invention comprises the following steps. A step in which a unit game is repeated in such a manner that the game is started by scrolling a plurality of symbols which have been arranged in the display area of a display based on the control of the controller, and the game is completed by stopping the plurality of symbols at the combination determined by the controller for rearrangement, whereby automatically stopping the symbols being scrolled. A step in which the symbols which have been displayed in another display area which is different from the display area are scrolled until the symbols being scrolled in the display areas are automatically stopped, and the symbols being scrolled in the other display area are allowed to be rearranged based on an input signal from the stop switch connected to the controller. A step in which it is determined whether or not the symbol rearranged in the other display area turns out to be a specific symbol. And a step in which the number of activated winning combinations of the symbols in the display area of the display is increased if it is determined that the rearranged symbol has been a specific symbol.

With the playing method executed by the slot machine of the sixth aspect of the present invention, a unit game is executed in which the stop switch is activated when scrolling of the symbols is started in another display area, and further, when the player operates the stop switch, the symbols being scrolled in another display area are rearranged at the timing of the operation. Then, if the rearranged symbol turns out to be a specific symbol, the number of activated winning combinations is increased.

### BRIEF DESCRIPTION OF THE DRAWINGS

FIG. 1 is a flow chart illustrating the playing method of the slot machine according to one embodiment of the present invention.

FIG. 2 is a perspective view illustrating the appearance of the slot machine according to one embodiment of the present invention.

FIG. 3 is a list of symbols and code numbers of respective symbols to be displayed in the respective columns of the display areas of the slot machine according to one embodiment of the present invention.

FIG. 4 is a payout table indicating the relation between winning combinations and payout thereof.

FIG. 5 is a block diagram illustrating the control circuit of the slot machine according to one embodiment of the present invention.

FIG. 6 is a flow chart illustrating the procedure of the authentication reading processing of the gaming program and the gaming system program executed by the motherboard and the gaming board of the slot machine according to one embodiment of the present invention.

FIG. 7 is a flow chart illustrating the procedure of the base game executed by the slot machine according to one embodiment of the present invention.

FIG. 8 is a flow chart illustrating the procedure of the stop control game executed by the slot machine according to one embodiment of the present invention.

FIG. 9 is a flow chart illustrating the procedure of the determination process of the symbols to be stopped, which is executed by the slot machine according to one embodiment of the present invention.

FIG. 10 is a flow chart illustrating the procedure of the scroll process of symbols executed by the slot machine according to one embodiment of the present invention.

FIG. 11 is a flow chart illustrating process sequence of the bonus game executed by the slot machine according to one embodiment of the present invention.

FIG. 12 is an illustration of an exemplary display for notifying that the stop control game is being executed on the slot machine according to one embodiment of the present invention.

FIG. 13 is an illustration of when a combination of the symbol “LOBSTER”s has come to a stop along the payline of a display area in the slot machine according to one embodiment of the present invention.

FIG. 14 is an illustration of display areas and a reel when the stop control game is being executed in the slot machine according to one embodiment of the present invention.

FIG. 15 is an illustration of when a symbol of “OCTOPUS” has come to a stop by execution of the stop control game in the slot machine according to one embodiment of the present invention.

### DETAILED DESCRIPTION OF THE INVENTION

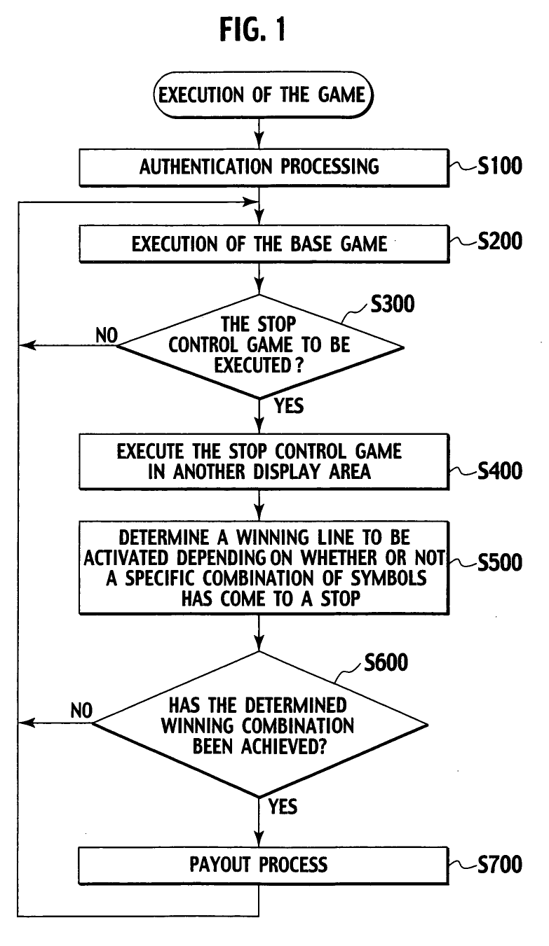

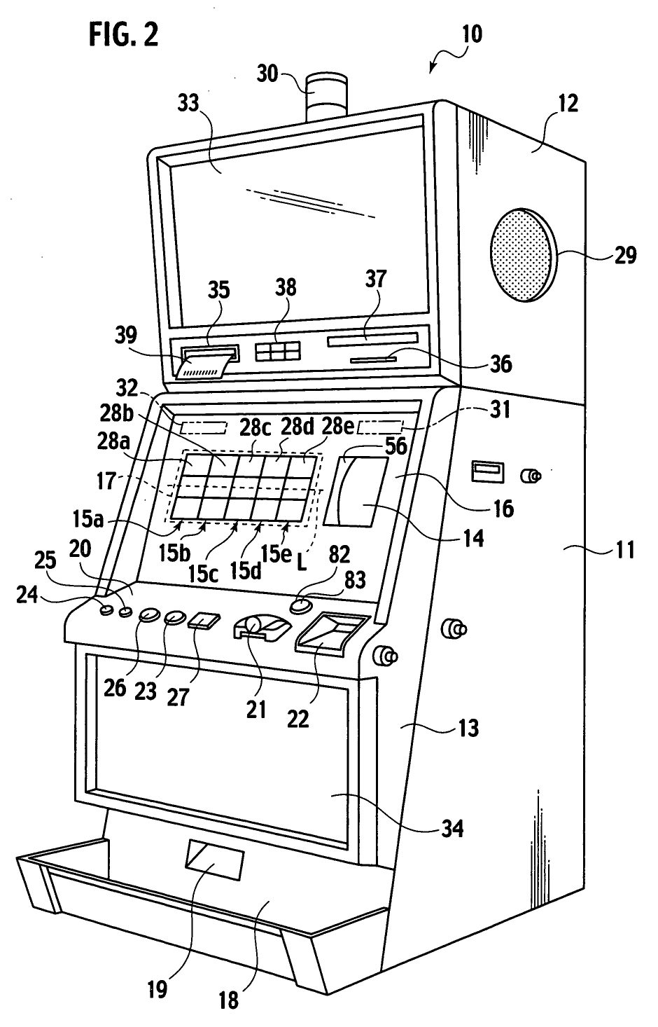

FIG. 1 is a flow chart illustrating the overview of the playing method of the slot machine according to the present invention. The general operation of the slot machine and the playing method according to the present invention will be described below, referring to the flow chart shown in FIG. 1 and the perspective view shown in FIG. 2.

When the slot machine according to the present invention is powered on and starts up, an authentication processing is executed first (step S100). In this authentication processing, an initial checking processing is executed, prior to starting the unit game, in order to check whether or not the program for operating the system is normally activated, whether or not there is any falsification of program, etc.

Next, the base game is executed (step S200). In the base game, when the spin button 23 is pressed with a desired number of credits have been bet, such as by inserting a coin into the coin insertion slot 21, the symbols start to scroll on each of the display areas 28 of the liquid crystal display unit 17 inside a 5-column×3-row matrix of display windows 15 (15a to 15e) provided on the front side of the cabinet 11. Subsequently, a unit game is executed in which scrolling is stopped to bring (rearrange) the symbols to a stop on each of the fifteen (5-column×3-row matrix) display areas 28 (28a to 28e).

In each unit game, a process for determining the symbols to be stopped on each of the display areas 28 is executed. If a combination of symbols which may invoke the bonus trigger, for example, the symbol “APPLE”s have come to a stop oh the payline L provided as a middle lateral line of the display areas 28 (28a to 28e), the process proceeds to a bonus game.

In addition, if a predetermined condition, such that a predetermined symbol combination has come to a stop across the display areas 28 (28a to 28e), is satisfied, a stop control game is executed in which the symbols being scrolled on another display area (e.g., reel 14 shown FIG. 2) are stopped at the timing when the stop switch 82 is pressed by the player (steps S300 and S400).

When the stop control game is started, scrolling of the symbols which have been displayed in each of the display areas 28 (28a to 28e) in a stopped state is started. In addition, the reel 14 provided at the side of the display areas 28 of the cabinet 11 spins to start scrolling, activating the stop switch 82 provided below the reel 14. Subsequently, the spinning reel 14 stops when the player presses the stop switch 82. Then, winning combinations to be activated are determined depending on whether or not a specific symbol, for example a symbol “OCTOPUS” has come to a stop at a position viewable through the display window 56 provided in the front side of the reel 14 (step S500).

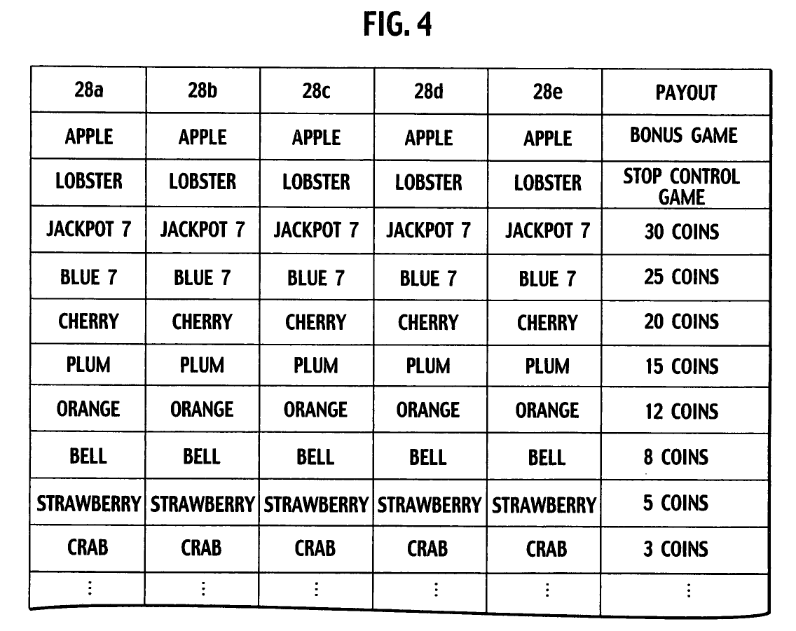

For example, as shown in FIG. 4, eight winning combinations such as all “JACKPOT 7”s, all “BLUE 7”s, all “CHERRY”s, all “PLUM”s, all “ORANGE”s, all “BELL”s, all “STRAWBERRY”s and all “CRAB”s are existing as winning combinations associated with payout, and it is determined which winning combinations are activated. For example, winning combinations all “JACKPOT 7”s, all “BLUE 7”s, all “CHERRY”s and all “PLUM”s have been activated initially, then winning combinations all “ORANGE”s and all “BELL”s are newly activated when a specific symbol such as “OCTOPUS” has successfully come to a stop at the middle level of the reel 14 (the other display area) by execution of the stop control game.

Subsequently, when each of the symbols being scrolled in the respective display areas 28 (28a to 28e) is stopped, it is determined whether or not the symbols composing the activated winning combination determined by the process of step S500 have come to a stop on the payline L (step S600).

If symbols composing the activated winning combination have come to a stop on the payline L, coins corresponding to this winning combination are paid out based on a preliminarily prepared payout table (see FIG. 4) (step S700). For example, when the symbol “OCTOPUS” has come to stop at the middle level of the reel 14 by execution of the stop control game, combinations all “ORANGE”s and all “BELL”s are newly activated as well as initially activated combinations all “JACKPOT 7”s, all “BLUE 7”s, all “CHERRY”s and all “PLUM”s.

In other words, the number of activated winning combinations increases if the player presses the stop switch 82 and succeeds in stopping the scrolling to align specific symbol such as the “OCTOPUS” with the reel 14 in the stop control game executed by the process of step S400. Therefore, completion rate of the winning combination associated with payout becomes higher, whereby raising the possibility of the player to obtain a larger amount of payout.

In addition, although the above example describes a case in which the symbols are stopped and displayed on fifteen (5-column×3-row) display areas 28 (28a to 28e), the present invention is not limited to a 5-column×3-row matrix of display areas 28. Furthermore, although an example is described in which the symbols are displayed in each of the display areas 28 using the liquid crystal display unit 17, a cylindrically-shaped, mechanical spin reel having a plurality of symbols displayed on its surface may be used in such a manner that the spin reel is stopped after having been spun, causing the symbols to stop inside each of the display windows 15 (15a to 15e).

Additionally, the above example is arranged such that the reel 14 provided on the side of the display areas 28 spins and scrolls when the stop control game is started, and scrolling of the reel 14 is stopped when the stop switch 82 is pressed by the player. However, for example, an arrangement may be employed such that the symbols for the stop control game are scrolled vertically or laterally, overlapping the display areas 28 provided inside the display windows 15 (15a to 15e), and the symbols for the stop control game are stopped by operation of the stop switch 82. In this case, the region on the liquid crystal display unit 17 which is displayed overlapping the display areas 28 (28a to 28e) provided inside the display windows 15 (15a to 15e) becomes an area (another display area) for displaying the symbols for the stop control.

Also in the above example, a case is described in which the stop control game is executed once when executing stop control games, and the number of the activated winning combinations is increased if the specific symbol (e.g., “OCTOPUS”) has come to a stop at the position viewable through the display window 56 provided at the middle level of the reel 14. However, the stop control game may be executed multiple times and the number of the activated winning combinations may be gradually increased each time a specific symbol come to a stop in each stop control game.

For example, it may be configured such that, when the stop control game is executed four times, the combination all “ORANGE”s is newly set as the activated winning combination if a specific symbol come to a stop in one out of the five stop control games, the combination all “BELL”s is newly set as the activated winning combination as well as all “ORANGE”s if a specific symbol come to a stop in two times out of the stop control games, the combination all “STRAWBERRY”s is newly set as the activated winning combination as well as all “ORANGE”s and all “BELL”s if a specific symbol come to a stop in three times out of the stop control games, and the combination all “CRAB”s is newly set as the activated winning combination as well as all “ORANGE”s, all “BELL”s and all “STRAWBERRY”s if a specific symbol come to a stop in all four times out of the stop control games.

Furthermore, the above example describes a base game in which the symbols are scrolled vertically relative to each of the 5-column×3-row display areas 28 (28a to 28e) and subsequently stopped (rearranged). However, the symbols may be switched over on each of the fifteen display areas 28 (28a to 28e) respectively, and displayed (rearranged).

Next, an arrangement of the slot machine 10 according to one embodiment of the present invention will be explained, referring to the perspective view shown in FIG. 2. The slot machine 10 is installed in a gaming facility.

With the slot machine 10, a coin, a bill, or electronic value information corresponding to these is used as game media for executing a unit game. However, in the present invention, the game media is not limited to those mentioned above and may include a medal, a token, an electronic money, a ticket, or the like, for example. In addition, the above-mentioned ticket may include but not limited to a bar-coded ticket described below, for example.

As shown in FIG. 2, the slot machine 10 comprises a cabinet 11, a top box 12 provided on the top of the cabinet 11, and a main door 13 provided on the front side of the cabinet 11.

Inside the cabinet 11, a liquid crystal display unit 17 is provided for scrolling a 5-column×3-row matrix of symbols inside display windows 15 (15a to 15e). The liquid crystal display unit 17 comprises display areas 28 (28a to 28e) for displaying the 5-column×3-row matrix of symbols through the display window 15. In other words, when the base game is executed, the symbols are scrolled in the 5-column×3-row matrix of display areas 28 (28a to 28e), allowing the player to view the symbols being scrolled through the display windows 15 (15a to 15e).

Here, in the present embodiment, a 5-column×3-row matrix of display areas 28 (28a to 28e) of the liquid crystal display unit 17 is described as an exemplary display. However, the symbols may be displayed through the display windows 15 by spinning and subsequently stopping mechanical reels with the symbols displayed on their side. Also, the matrix of display areas 28 is not limited to five columns and three rows.

In addition, a mechanical reel 14 is provided near the side of the liquid crystal display unit 17 inside the cabinet 11. On the surface of the reel 14, a plurality of symbols are displayed so that the player can view them through the display window 56 provided on the main door 13. The reel 14 spins to start scrolling when the stop control game is started, and when the stop switch 82 is pressed by the player, it stops scrolling at the timing when the stop switch 82 is pressed. Thus the player can view the symbols through the display window 56 when the reel 14 stopped.

Additionally, when the stop control game is started, the area surrounding the reel 14 is illuminated and a display lamp 83 provided in the stop switch 82 lights up, notifying the player that the spinning reel 14 can be stopped by pressing the stop switch 82.

In front of the liquid crystal display unit 17 in the main door 13 is provided a lower display panel 16. The lower display panel 16 has a transmissive liquid crystal panel to display, during the game, various information or staging images relating to the game.

A credit number display section 31 and a payout number display section 32 are provided in the lower display panel 16. The number of coins having been credited is displayed as images on the credit number display section 31.

The number of coins to be paid out is displayed as images on the payout number display section 32, if the combination of the symbols which have come to a stop on the payline L which is laterally provided at a middle row of the display areas 28 (28a to 28e) turns out to be a winning combination. In particular, each winning combination of the symbols shown in FIG. 4 and the number of coins to be paid out per bet are displayed on the payout number display section 32. And the activated winning combinations at the moment are notified to a player by lighting up images corresponding to the activated winning combinations. For example, images corresponding to the initially activated winning combinations all “JACKPOT 7”s, all “BLUE 7”s, all “CHERRY”s and all “PLUM”s light up and images corresponding to the other winning combinations doesn't. And the image corresponding to the winning combination all “ORANGE”s is lit up to notify a player that this winning combination all “ORANGE”s becomes newly activated when the winning combination all “ORANGE”s becomes newly activated.

A payline L defines a combination of symbols. If a combination of symbols which have come to a stop along a payline L is the activated winning combination, coins are paid out according to the winning combination and the number of coins which have been inserted (number of bets).

The lower display panel 16 is provided with five columns of display windows 15 (15a to 15e) through which the symbols displayed on the display areas 28 (28a to 28e) of the liquid crystal display unit 17 provided inside the lower display panel 16 are viewable.

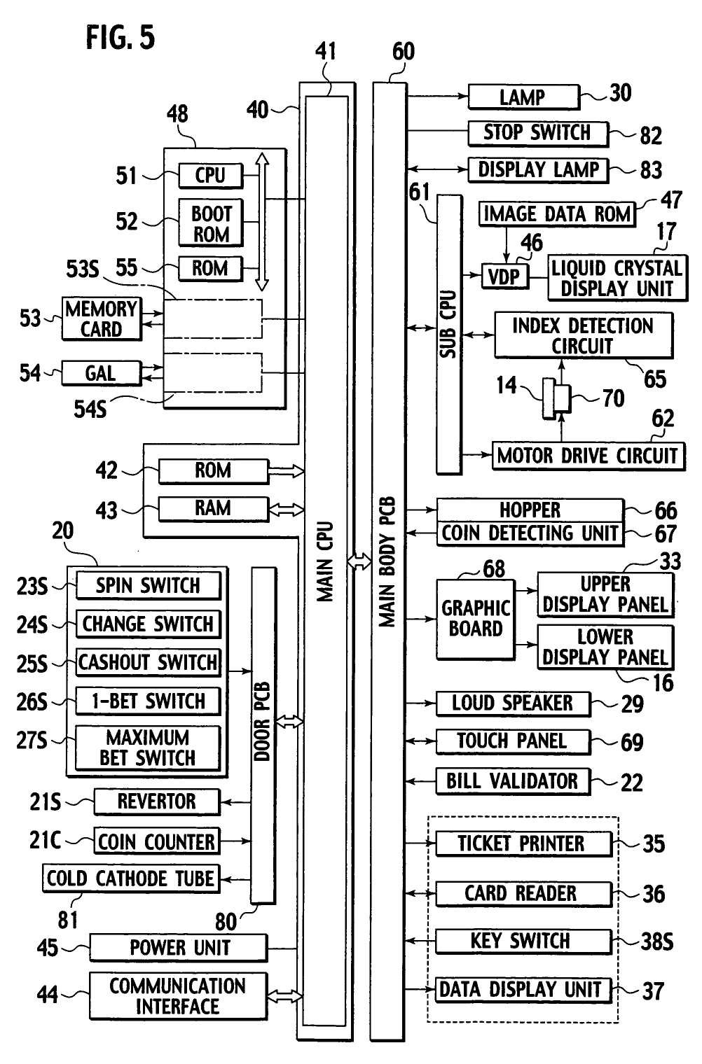

Furthermore, a touch panel 69 (see FIG. 5) is provided on the front side of the lower display panel 16, allowing the player to operate the touch panel 69 to input various commands.

At the bottom of the lower display panel 16 are provided a control panel 20 having a plurality of buttons 23 to 27 into which commands with regard to the progress of the game are entered by the player, a stop switch 82, a coin insertion slot 21 for accepting coins into the cabinet 11, and a bill validator 22.

In this embodiment, although an example is described in which a reel 14 is provided near the side of the liquid crystal display unit 17 and the stop control game is executed using the reel 14, an arrangement may be employed such that the symbols for the stop control game are displayed overlapping the display areas 28 of the liquid crystal display unit 17, the symbols for the stop control game being scrolled vertically or laterally, and the symbols for the stop control game are stopped at the timing when the player pressed the stop switch 82.

In this case, by providing a transmissive touch panel on the front side of the display windows 15 in place of the mechanical stop switch 82, the touch panel may be used in place of the stop switch 82. As such a touch panel, a touch panel employed in mobile terminals or ATMs of banks may be used. As thus described, the player can provide instructions for rearrangement by touching the symbols he or she wants to stop (rearrange) while viewing the changing states of the symbols displayed overlapping the display areas 28 for the stop control game through the window 15 by providing a touch panel as the stop switch 82 on the front side of the display windows 15. Such a rearrangement operation is advantageous in that the operation can be performed with a feel that the player is directly touching the symbol.

The control panel 20 has a spin button 23, a change button 24, a cash out button 25, a 1-bet button 26, and a maximum bet button 27 provided therein. The spin button 23 is a button for inputting the start of scrolling command of the symbols displayed on the display areas 28. The change button 24 is a button used when requesting money exchange to the crew of a gaming facility. The cash out button 25 is a button for entering commands to payout the credited coins into the tray 18.

The 1-bet button 26 is a button for inputting a command to bet a single coin on the game from the coins which have been credited. The maximum bet button 27 is a button for inputting a command to bet on the game a maximum number (e.g., 50) of coins allowed to be bet on a single game from those which have been credited.

The stop switch 82 is a switch, which is activated when the stop control game is started, for allowing the player to perform an operation to stop the spinning reel 14. In addition, a display lamp 83 is provided in the stop switch 82. The display lamp 83 lights up when the operation of the stop switch 82 is activated and notifies the player that the operation of the stop switch 82 is activated, as discussed below. Note that, an operation lever, a track ball, a touch panel, or the like may be used in place of the stop switch 82.

The bill validator 22 identifies whether or not the bill is authentic and accepts legitimate bills into the cabinet 11. Here, the bill validator 22 may be configured to be able to read a bar-coded ticket 39 described below. A berry glass 34 having characters of the slot machine 10 drawn thereon is provided on the lower front side of the main door 13, i.e. at the bottom of control panel 20.

On the front side of top box 12 is provided an upper display panel 33. The upper display panel 33 comprises a liquid crystal panel to display staging images, introduction of game contents, and rules of the games, for example.

In addition, a loudspeaker 29 for audio output is provided on the top box 12. At the bottom of the upper display panel 33 are provided a ticket printer 35, a card reader 36, a data display unit 37, and a key pad 38. The ticket printer 35 prints bar codes on the ticket, which are coded data such as the number of credits, date/time, and the identification number of the slot machine 10 and outputs the ticket as the bar-coded ticket 39. The player can play games on other slot machines using the bar-coded ticket 39, or exchange the bar-coded ticket 39 with bills at the cashier of the gaming facility.

The card reader 36 reads and writes data from and to a smart card. The smart card is a card carried by the player, and stores data used for identifying the players or data relating to the gaming history played by the player.

The data display unit 37 comprises a fluorescent display or the like, and displays data read by the card reader 36 or data entered by the player using the key pad 38, for example. The key pad 38 inputs commands or data with regard to ticket publication.

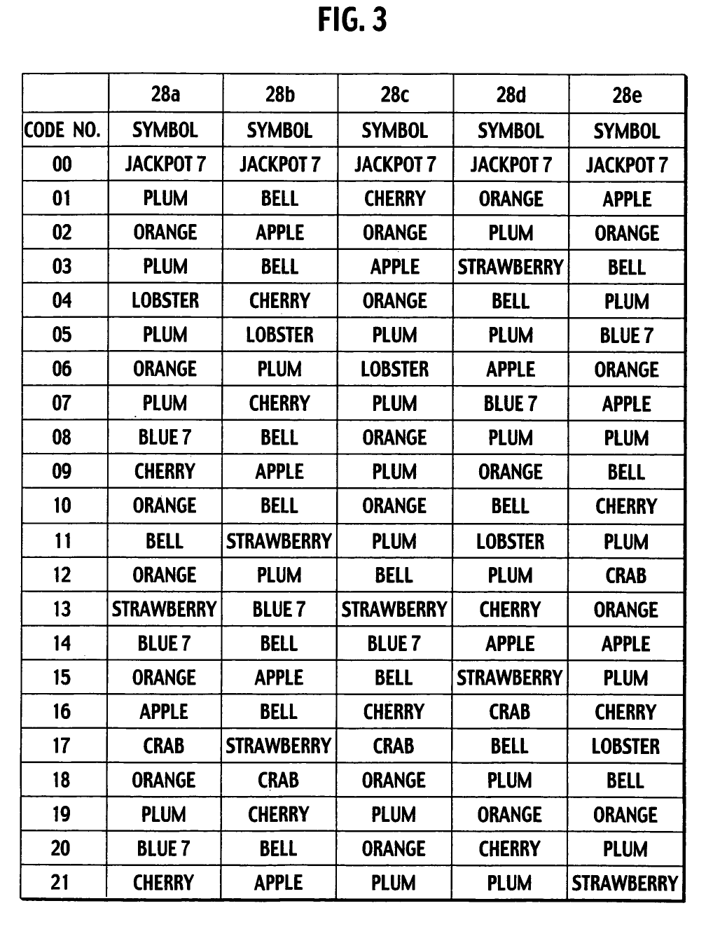

FIG. 3 is an explanatory list of columns of symbols to be scrolled on each of the display areas 28 provided on the liquid crystal display unit 17 installed in the cabinet 11. As shown in FIG. 3, columns of a total of 22 symbols composed of code number “00” to “21”, respectively, are scrolled on each of the display areas 28. The columns of symbols are different for each of the display areas 28.

The symbols to be displayed on each of the display areas 28 are composed by combining the symbols “JACKPOT 7”, “BLUE 7”, “BELL”, “CHERRY”, “STRAWBERRY”, “PLUM”, “ORANGE”, “APPLE”, “LOBSTER”, and “CRAB”. In addition, an activated winning combination is set by combination of the above symbols. Additionally, a payout table is set as tables for determining the payout when a winning combination is achieved.

FIG. 4 shows the payout table. The payout table defines the payout for the symbols which have come to a stop along the payline L. For example, when a combination of the symbol “APPLE”s has come to a stop along the payline L, a bonus trigger is invoked, shifting the game state from the base game to the bonus game.

Additionally, a stop control game using the reel 14 is executed if a combination of the symbol “LOBSTER”s has come to a stop along the payline L, which is the middle row across the five columns of the display areas 28.

In addition, if the symbol “JACKPOT 7”s have come to a stop along the payline L in FIG. 4, payout of 30 coins per bet is made, payout of 25 coins per bet is made if the symbol “BLUE 7”s have come to a stop, payout of 20 coins per bet is made if the symbol “CHERRY”s have come to a stop, and payout of 15 coins per bet is made if the symbol “PLUM”s have come to a stop. Additionally, if the symbol “ORANGE”s have come to a stop along the payline L, payout of 12 coins per bet is made, payout of eight coins per bet is made if the symbol “BELL”s have come to a stop, payout of five coins per bet is made if the symbol “STRAWBERRY”s have come to a stop, and payout of three coins per bet is made if the symbol “CRAB”s have come to a stop.

And each of the winning combinations shown FIG. 4 is determined whether or not it is activated based on the results of executing the stop control games described below.

The bonus game executed when the symbol “APPLE”s have come to stop along the payline is a game state which is more advantageous than the base game. In the present embodiment, the bonus game is a free game (a game playable for a predetermined number of times without betting a coin). In the present invention, the bonus game is not particularly limited as long as it is an advantageous game state for the player. Also, the form of a bonus game which is advantageous for the player is not particularly limited as long as it is more advantageous than the base game, including, for example, a state in which more game media can be obtained than the base game, a state in which game media can be obtained with a higher probability than with the base game, or a state in which consumption of game media is less than the base game, or the like. Specifically, a bonus game may include a free game, a second game or the like.

The symbols respectively displayed (arranged) in the 5 columns×3 rows display areas 28 (28a to 28e), when the 1-bet button 26 or the maximum-bet button 27 is pressed and thereafter the spin button 23 is pressed, starts scrolling. When scrolling of each symbol is started, scrolling of each symbol comes to stop (rearranged) after the predetermined period of time has passed. At this time, any one of symbols of columns of symbols in each display area 28 shown in FIG. 3 comes to a stop in the display areas 28 (28a to 28e) to be inside of the display windows 15 (15a to 15e).

Further, when various winning combinations (refer to FIG. 4) are predetermined for each symbol and the winning combination activated by executing the stop control games described below comes to a stop along the payline L, the number of payout coins corresponding to the winning combination is added to the number of credits owned by the player. Further, when a bonus game trigger is invoked, that is, in the present embodiment, five symbols of “APPLE” come to a stop along the payline L, the game state shifts from base game state to bonus game state.

FIG. 5 is a block diagram illustrating a control circuit of the slot machine 10 shown in FIG. 2. As shown in FIG. 5, the control circuit comprises a motherboard 40, a main body PCB (Printed Circuit Board) 60, a gaming board 50, a sub CPU 61, a door PCB 80, and various types of components such as switches or sensors. The motherboard 40 and the gaming board 50 constitute a controller 48.

The gaming board 50 comprises a CPU (Central Processing Unit) 51, a ROM 55 and a boot ROM 52, which are connected to each other by an internal bus, a card slot 53S corresponding to a memory card 53, and an IC socket 54S corresponding to a GAL (Generic Array Logic) 54.

The Memory card 53 stores gaming programs and gaming system programs. The gaming programs include a stop symbol determination program. The stop symbol determination program is a program for determining the symbol (code number corresponding to the symbol) to be stopped on the payline L of each of the display areas 28 (28a to 28e). The stop symbol determination program includes symbol weighting data corresponding to each of a plurality of payout rates (e.g., 80%, 84%, and 88%). The symbol weighting data indicates the relation between the code numbers (see FIG. 3) of respective symbols and one or more random number values within a predetermined numerical range (0 to 255), respectively for the five columns of the display areas 28 (28a to 28e).

The payout rate is defined based on the payout rate setting data which is output from the GAL 54. Based on the symbol weighting data corresponding to the payout rate, the symbols to be stopped are determined.

In addition, the card slot 53S, configured to be capable of inserting therein and removing therefrom the memory card 53, is connected to the motherboard 40 by the IDE bus. Thus, the type or content of the game to be executed on the slot machine 10 can be changed by removing the memory card 53 from the card slot 53S, writing another gaming program and gaming system program in the memory card 53, and inserting the memory card 53 into the card slot 53S.

The gaming programs include a program relating to the progress of the game and a program for shifting the state to the bonus game. In addition, the gaming programs include image data and sound data to be output during the game. Furthermore, the gaming programs include image data and sound data as notification data for notifying the player, when the stop control game is started by the procedure described below, that the stop operation of the reel 14 using the stop switch 82 is activated.

The GAL 54 comprises a plurality of input ports and output ports and, when data is entered in an input port, outputs data corresponding to the entered data from an output port. The data output from the output port is the payout rate setting data mentioned above.

In addition, IC socket 54S, configured to be capable of attaching thereto and removing therefrom the GAL 54, is connected to the motherboard 40 by the PCI bus. Thus, the payout rate setting data to be output from the GAL 54 can be changed by removing the GAL 54 from the IC socket 54S, rewriting the program to be stored in the GAL 54, and attaching the GAL 54 to the IC socket 54S.

The CPU 51, the ROM 55 and the boot ROM 52 connected to each other by an internal bus are connected to the motherboard 40 by PCI bus. The PCI bus transmits signals between the motherboard 40 and the gaming board 50, as well as supplying power from the motherboard 40 to the gaming board 50. The ROM 55 stores country identification information and an authentication program. The boot ROM 52 stores a preliminary authentication program and a program (boot code) by which the CPU 51 starts the preliminary authentication program.

The authentication program is a program for certifying the gaming program and the gaming system program (falsification check program). The authentication program is a program for checking and proving that the gaming program and the gaming system program have not been falsified with. In other words, the authentication program is written in accordance with the certifying procedure of the gaming program and the gaming system program. The preliminary authentication program is program for certifying the authentication program. The preliminary authentication program is written in accordance with the procedure of certifying the authentication program, that is, to prove that the authentication program supposed to execute the authentication processing has not been falsified with.

The motherboard 40 comprises a main CPU 41, a ROM (Read Only Memory) 42, a RAM (Random Access Memory) 43, and a communications interface 44.

The main CPU 41 controls, when credits have been bet and the spin button 23 is pressed, outputting a command signal to cause the sub CPU 61 to scroll the symbols on each of the display areas 28 of the liquid crystal display unit 17, determining the symbols to be stopped at a position on each of the display areas 28 after the symbols on each of the display areas 28 have been started scrolling, and displaying the symbols in such a manner that the determined symbols stop on each of the display areas 28 (28a to 28e) through each display windows 15 (15a to 15e).

In other words, the main CPU 41 has a functionality as an arrangement controller for controlling the arrangement in order to rearrange, after putting a plurality of symbols displayed on the display (liquid crystal display unit 17) in a scrolling state, the symbols into a new symbol matrix, in such a manner that the symbols to be arranged into a symbol matrix are selected and determined from a plurality of types of symbols and the determined symbols are stopped from the scrolling state.

In addition, the main CPU 41 has a functionality for executing the stop control game which activates the stop switch 82 in the following unit game if a combination of a predetermined combination of the symbols (e.g., symbol “LOBSTER”s) has been rearranged on the payline L provided for the symbol matrix and allows rearrangement of the symbols being displayed on the reel 14 in accordance with the input timing of the stop switch 82 by the player.

Furthermore, the main CPU 41 has a functionality for increasing the number of winning combinations to be activated when a specific symbol has been rearranged in the stop control game (for example, the reel 14 has come to a stop with a symbol “OCTOPUS”) than when this specific symbol has not been rearranged.

The ROM 42 stores programs such as the BIOS (Basic Input/Output System) executed by the main CPU 41 and also stores data to be used permanently. When the BIOS is executed by the main CPU 41, an initialization process of each peripheral unit is executed and a read process for reading the gaming program and the gaming system program stored in the memory card 53 via the gaming board 50 is started.

The RAM 43 stores data and programs used when the main CPU 41 executes the processes.

The communications interface 44 is for providing communication between the host computer and the like provided in the gaming facility via a communication network.

In addition, a main body PCB (Printed Circuit Board) 60 and a door PCB 80, which will be described below, are connected to the motherboard 40 by a USB (Universal Serial Bus), respectively. Furthermore, a power unit 45 is connected to the motherboard 40. When electric power is supplied to the motherboard 40 from the power unit 45, the main CPU 41 of the motherboard 40 is activated, and electric power is also supplied to the gaming board 50 via a PCI bus, activating the CPU 51.

Devices and units which generate input signals to be fed to the main CPU 41, as well as devices and units whose operation is controlled by control signals output from the main CPU 41 are connected to the main body PCB 60 and the door PCB 80. The main CPU 41 executes arithmetic processes and stores their result in the RAM 43, or transmits control signals to respective devices and units as control processes for the respective devices and units, by executing the gaming programs and the gaming system program stored in the RAM 43, based on input signals fed to the main CPU 41.

To the main body PCB 60 are connected: a lamp 30, a sub CPU 61, a hopper 66, a coin detecting unit 67, a graphic board 68, a loudspeaker 29, a touch panel 69, a bill validator 22, a ticket printer 35, a card reader 36, a key switch 38S, and a data display unit 37. Furthermore, a stop switch 82 and a display lamp 83 provided corresponding to the stop switch 82 are connected to the main body PCB 60.

The turning on and off of the lamp 30 is controlled based on control signals output from the main CPU 41.

The sub CPU 61 controls the scrolling of the symbols on the fifteen (5 columns×3 rows) display areas 28 (28a to 28e) provided on the liquid crystal display unit 17, and is connected to the VDP (Video Display Processor) 46.

The VDP 46 reads out the image data of symbols stored in the image data ROM 47, generates scroll images to be displayed on the liquid crystal display unit 17, and outputs the scroll images to the liquid crystal display unit 17.

In addition, a motor drive circuit 62 for controlling the spin of the reel 14 is connected to the sub CPU 61. A stepping motor 70 is connected to the reel 14. The stepping motor 70 starts to rotate by a driving signal output from the motor drive circuit 62, whereby the reel 14 starts to spin. Also the sub CPU 61 executes a control to stop the spinning reel 14 upon accepting the input operation of the stop switch 82 and detecting that the stop switch 82 has been operated by the player.

The reel 14 has an index detection circuit 65 connected thereto for detecting the position where the reel 14 has stopped. The data which is detected by the index detecting circuit 65, indicating the position where the reel 14 has stopped, is output to the sub CPU 61. Based on the data, the sub CPU 61 can recognize the position, that is, with which symbols the reel has come to a stop.

The hopper 66 is provided inside the cabinet 11 and pays out a predetermined number of coins from the coin payout opening 19 to the coin tray 18 based on control signals output from the main CPU 41. The coin detecting unit 67 is provided inside the coin payout opening 19 and outputs the input signal to the main CPU 41 if it has detected that a predetermined number of coins have been paid out from the coin payout opening 19.

The graphic board 68 controls display of images in the upper display panel 33 and lower display panel 16 except the symbols to be displayed on the display areas 28, based on control signals output from the main CPU 41. The number of credits stored in the RAM 43 is displayed on the credit number display section 31 of the lower display panel 16. In addition, the number of coins paid out is displayed on the payout number display section 32 of the lower display panel 16. In addition, the graphic board 68 comprises a VDP for generating image data based on control signals output from the main CPU 41 and a video RAM for temporarily storing the image data generated by the VDP.

The bill validator 22 reads the images of the bills to accept legitimate bills into the cabinet 11. In addition, upon accepting a legitimate bill, the bill validator 22 outputs an input signal to the main CPU 41 according to the value of the bill. The main CPU 41 stores, in the RAM 43, a number of credits corresponding to the value of the bill, the value having been transmitted by the input signal.

The ticket printer 35 prints, based on control signals output from the main CPU 41, bar codes on the ticket expressing coded data such as number of credits stored in the RAM 43, time and date, identification number of the slot machine 10, or the like, and outputs the bar-coded ticket 39.

The card reader 36 reads data from the smart card and transmits the data to the main CPU 41, or writes data into the smart card based on control signals from the main CPU 41. The key switch 38S is provided on the key pad 38 and outputs, when the key pad 38 is operated by the player, the entered signal to the main CPU 41.

The data display unit 37 displays, based on control signals output from the main CPU 41, the data read by the card reader 36 or the data entered via the key pad 38 by the player.

The stop switch 82 is a button for stopping the reel 14 when the stop control game described below is executed. When the stop control game is executed, the stop switch 82 is activated and the display lamp 83 provided at the operating portion of the stop switch lights up. When the stop switch 82 is pressed by the player, the sub CPU 61 controls the symbols being scrolled to be stopped at the timing of pressing the button.

A control panel 20, a revertor 21S, a coin counter 21C, and a cold cathode tube 81 are connected to the door PCB 80. On the control panel 20, a spin switch 23S corresponding to the spin button 23, a change switch 24S corresponding to the change button 24, a cash out switch 25S corresponding to the cash out button 25, a 1-bet switch 26S corresponding to the 1-bet button 26, and a maximum bet switch 27S corresponding to the maximum bet button 27 are provided. Respective switches 23S to 27S output, when their corresponding buttons 23 to 27 are operated by the player, the input signals to the main CPU 41.

The coin counter 21C is provided inside the coin insertion slot 21 and discriminates whether or not the coin inserted into the coin insertion slot 21 by the player is legitimate. Coins other than legitimate ones are ejected from the coin payout opening 19. In addition, upon detecting a legitimate coin, the coin counter 21C outputs the input signal to the main CPU 41.

The revertor 21S operates based on control signals output from the main CPU 41 to distribute the coins recognized as legitimate coins by the coin counter 21C to either the cashbox (not shown) or the hopper 66 provided inside the slot machine 10. In other words, when the hopper 66 is filled with coins, legitimate coins are distributed to the cashbox by the revertor 21S. On the other hand, when the hopper 66 is not filled with coins, legitimate coins will be distributed to the hopper 66.

The cold cathode tube 81 functions as a back light provided in the lower display panel 16 and the back side of the upper display panel 33, and lights up based on control signals output from the main CPU 41.

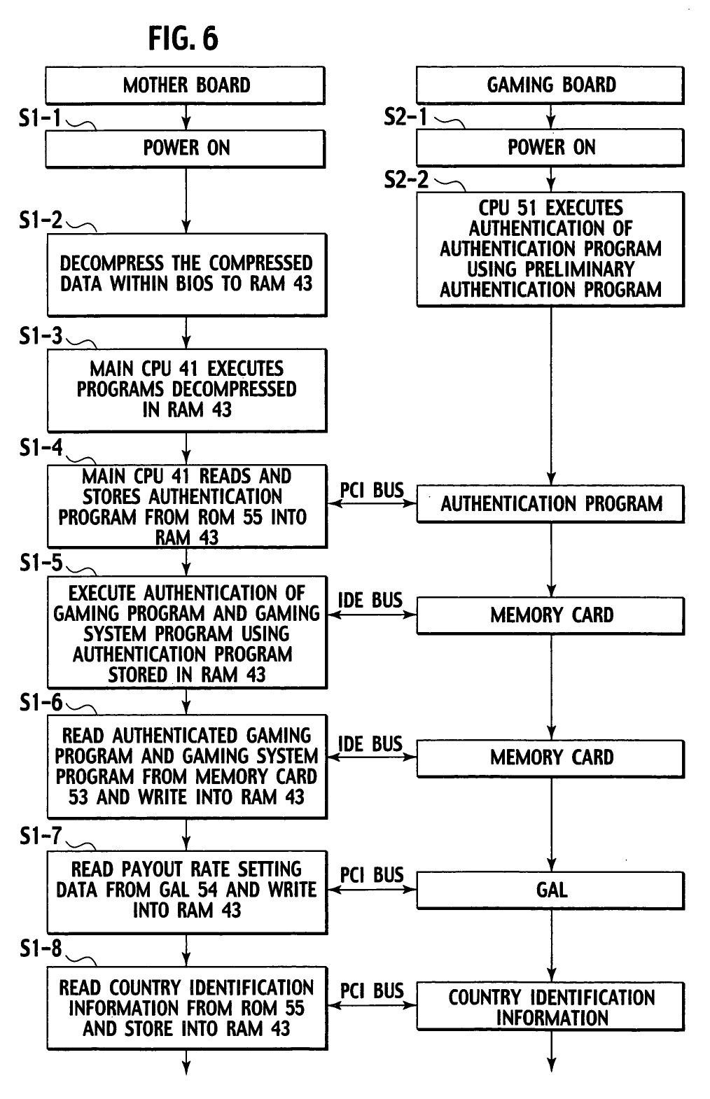

Next, a specific process executed in the slot machine 10 will be described. FIG. 6 is a flow chart illustrating the procedure (process of step S100 shown in FIG. 1) of the authentication reading processing of the gaming program and the gaming system program executed by the motherboard 40 and the gaming board 50 shown in FIG. 5. Here, it is assumed that a memory card 53 is attached to the card slot 53S on the gaming board 50, and GAL 54 is attached to the IC socket 54S.

First, upon switching on the power switch in the power unit 45, the motherboard 40 and the gaming board 50 are activated (steps S1-1 and S2-1). When the motherboard 40 and the gaming board 50 are activated, separate processes are executed in parallel. Specifically, in the gaming board 50, the CPU 51 reads out the preliminary authentication program stored in the boot ROM 52 and executes a preliminary authentication in accordance with the read-out preliminary authentication program to check and prove, before taking into the motherboard 40, that the authentication program has not been falsified with (step S2-2).

On the other hand, in the motherboard 40, the main CPU 41 executes the BIOS stored in the ROM 42 and decompresses the compressed data embedded in the BIOS to the RAM 43 (step S1-2). Then the main CPU 41 executes the BIOS which has been decompressed into the RAM 43 and executes diagnosis and initialization of various peripheral units (step S1-3).

Then, since the ROM 55 of the gaming board 50 is connected to the main CPU 41 via the PCI bus, the main CPU 41 reads out the authentication program stored in the ROM 55. Furthermore, the main CPU 41 executes a process to store the read-out authentication program in the RAM 43 (step S1-4).

Next, the main CPU 41 accesses the memory card 53 attached to the card slot 53S via the IDE bus. Then, the main CPU 41 reads out the gaming program and the gaming system program stored in the memory card 53.

Next, the main CPU 41 executes authentication to check and prove, in accordance with authentication program stored in the RAM 43, that the read-out gaming program and the gaming system program have not been falsified with (step S1-5).

If the authentication processing is completed normally, the main CPU 41 stores the certified gaming program and gaming system program into the RAM 43 (step S1-6). Next, the main CPU 41 accesses the GAL 54 connected to the IC socket 54S via the PCI bus, and reads the payout rate setting data from GAL 54 and stores it into the RAM 43 (step S1-7). Next, the main CPU 41 reads the country identification information stored in the ROM 55 of the gaming board 50 via the PCI bus, and stores the read-out country identification information in the RAM 43 (step S1-8).

After executing the above-mentioned process, the main CPU 41 advances the base game as described below, by sequentially reading out and executing the gaming program and the gaming system program.

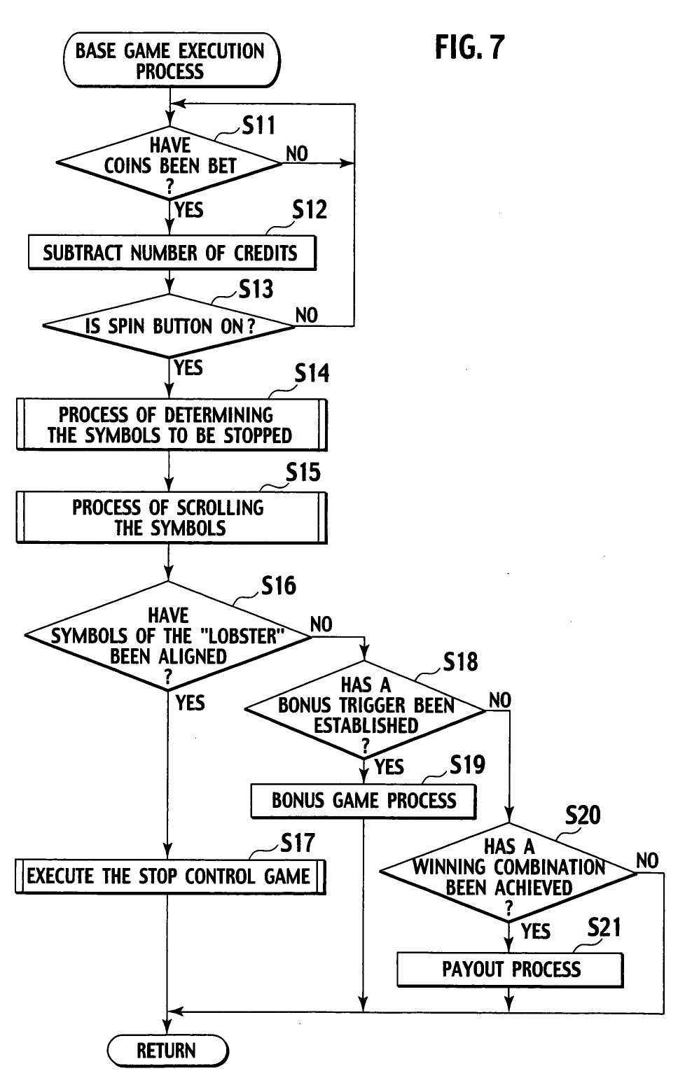

After the authentication reading process shown in FIG. 6 has been executed, the main CPU 41 starts the execution process of the base game. FIG. 7 is a flow chart illustrating a specific process sequence of execution process of the base game shown in step S200 of FIG. 1.

In base game execution process, the main CPU 41 first determines whether or not a coin has been bet (step S11). In this process, the main CPU 41 determines whether or not an input signal which is output from the 1-bet switch 26S when the 1-bet button 26 is pressed, or an input signal which is output from the maximum bet switch 27S when the maximum bet button 27 is pressed is accepted. If it is determined that no coin has been bet, the process returns to step S11.

On the other hand, if it is determined in step S11 that coins have been bet, the main CPU 41 executes a process to subtract the number of credits stored in the RAM 43 according to the number of coins bet (step S12). Here, if the number of coins bet is larger than that of credits stored in the RAM 43, the process returns to step S11 without subtracting the number of credits stored in the RAM 43. In addition, if the number of coins bet exceeds an upper limit (50 in the present embodiment) which can be bet for a single game, the process proceeds to step S13 without subtracting the number of credits stored in the RAM 43. In this condition, the symbols can be displayed in a scrolling state on the display areas.

Next, the main CPU 41 determines whether or not the spin button 23 is turned on (step S13). In this process, when the spin button 23 is turned on the main CPU 41 determines whether or not an input signal which is output from the spin switch 23S is accepted.

If it is determined that the spin button 23 has not been turned on, the process returns to step S11. Here, the main CPU 41 cancels the subtraction result in step S12 if the spin button 23 is not turned on (for example, a command to finish the game has been input without turning on the spin button 23).

In the present embodiment, a case will be described in which a process of subtracting the number of credits (step S12) is executed after the coins have been bet (step S11) and before determining whether or not the spin button 23 has been turned on (step S13). However, the present invention is not limited to this. For example, whether or not the spin button 23 has been turned on may be determined (step S13) after the coins have been bet (step S11), then the process of subtracting the number of credits (step S12) may be executed if it is determined that the spin button 23 has been turned on (YES in step S13).

Then the main CPU 41 executes a process of determining the symbols to be stopped (step S14) if it is determined that spin button 23 has been turned on in step S13 of FIG. 7. In this process of determining the symbols to be stopped, the main CPU 41 determines, by executing a stop symbol determination program stored in the RAM 43, the symbols to come to a stop on each of the 5 columns×3 rows display areas 28 (28a to 28e). This determines the combinations of the symbols which will come to a stop on the payline L.

Next, the main CPU 41 executes a process of scrolling the symbols (step S15). This is a process which stops, after scrolling of the symbols on each of the display areas 28 has been started, the symbols so that the symbols determined in step S14 will stop on the display areas 28.

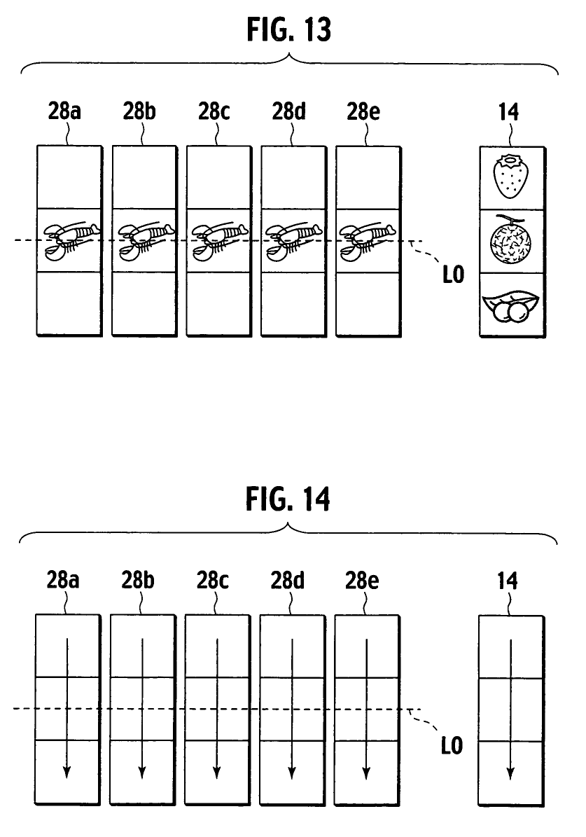

Next, the main CPU 41 determines whether or not the combination of the symbols which has come to a stop on the payline L is a predetermined combination of “LOBSTER”s (step S16), and executes a stop control game described below (step S17) if the combination of “LOBSTER”s has come to a stop on the payline L as shown in FIG. 13. Here, the occasion that a predetermined combination stopped multiple times in succession may be used as a trigger to execute the stop control game. For example, it may be configured such that the stop control game is executed if the combination of “LOBSTER”s stopped on the payline L three times in succession.

On the other hand, if the combination of the symbols which has come to a stop on the payline L is not the combination of “LOBSTER”s, it is determined whether or not the bonus trigger has been established, i.e., the combination of “APPLE”s has come to a stop on the payline L. If it is determined that the bonus trigger has been established, the bonus game process described below is executed (step S18).

In addition, if the bonus trigger has not been established, it is determined whether or not the activated winning combination has come to a stop (step S20). The initially activated winning combinations are “JACKPOT 7”s, “BLUE 7”s, “CHERRY”s and “PLUM”s. Therefore, for example, if the combination of “CHERRY”s has come to a stop, payout with 20 coins is made (step S21).

When saving the coins paid out, the main CPU 41 adds a predetermined number of credits to the number of credits stored in the RAM 43. In addition, when paying out coins, the main CPU 41 transmits a control signal to the hopper 66 and executes payout of a predetermined number of coins. In this circumstance, the coin detecting unit 67 counts the number of coins to be paid out from the hopper 66, and transmits a payout completion signal to the main CPU 41 when the counted value reaches a specified number. This causes the main CPU 41 to stop the operation of the hopper 66, and the coin payout process is completed.

If it is determined that the activated winning combination has not been achieved (NO in step S20), i.e., in a losing event, payout of coins is not executed. And, for example, the winning combination of “BELL”s is treated the same as a losing if the winning combination of “BELL”s had not be activated even when the winning combination of “BELL”s has come to a stop. The base game is executed in this manner.

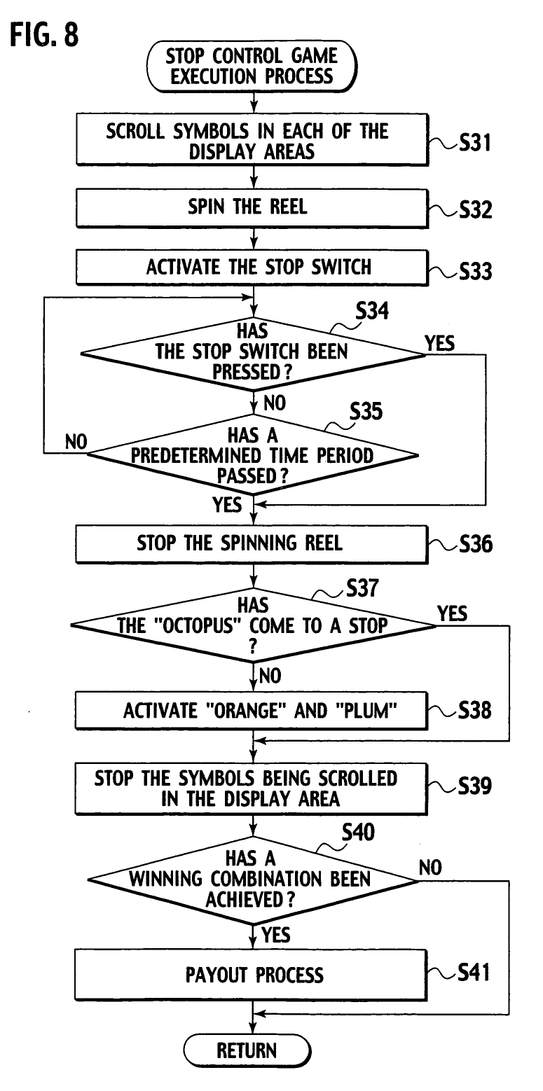

FIG. 8 is a flow chart illustrating a process sequence of the stop control game. When the stop control game is executed in the process of step S17 shown in FIG. 7, the main CPU 41 scrolls the symbols in each of the 5-column display areas 28 (28a to 28e) (step S31). In this case, in the process of step S31, scrolling of the symbols may be started automatically when the stop control game is executed, that is when the symbol “LOBSTER”s have come to a stop in the process of step S16 of FIG. 7, or scrolling of the symbols may be started after the 1-bet button 26 or the maximum bet button 27 is newly pressed and the spin button 23 is pressed.

Then, the main CPU sends a command signal to spin the reel 14 to sub CPU 61 and the sub CPU 61 sends a command signal to spin the reel 14 to the motor drive circuit 62. And the motor drive circuit 62 drives the stepping motor 70 to rotate and then the reel 14 rotates (Step S32). Consequently, symbols are scrolled on the display areas 28 and the reel 14 spins to scroll the symbols on the reel 14, as shown FIG. 14.

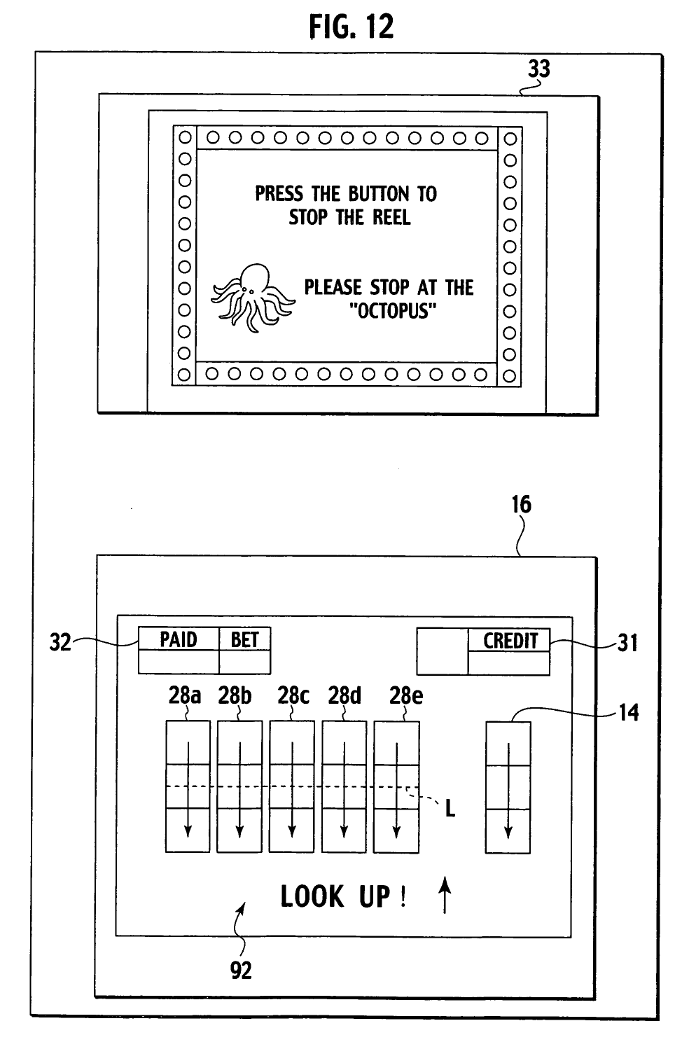

At this time, the main CPU 41 activates the operation of the stop switch 82 (step S33). In other words, the spinning reel 14 can be stopped by the player's operation of pressing the stop switch 82. Furthermore, the display lamp 83 provided to the stop switch 82 lights up. In addition, character strings “PRESS THE BUTTON TO STOP THE REELS” and “PLEASE STOP AT THE “OCTOPUS”” are displayed on the upper display panel 33 of the slot machine 10, as shown in FIG. 12. Furthermore, an arrow pointing upward and an image 92 showing “LOOK UP!” are displayed at the bottom of the lower display panel 16, whereby the player can be notified that the stop control game is being executed. Notification using audio or illuminations may be provided simultaneously.

Next, the main CPU 41 determines whether or not the stop switch 82 is pressed (step S34). If the stop switch 82 is pressed, the main CPU 41 stops the spinning reel 14 at the timing when the stop switch 82 is pressed (step S36). In this case, the main CPU 41 accepts the detection signal of the detection sensor (not shown) provided in the stop switch 82 and stops the spinning reel 14 upon detecting that stop switch 82 is pressed.

In addition, if the stop switch 82 has not been pressed (NO in step S34) by the player and a predetermined time period has passed (YES in step S35), the spinning reel 14 is automatically stopped (step S36).

Subsequently, the main CPU 41 determines whether or not the specific symbol “OCTOPUS” has come to a stop at the middle level (display position of the display window 56) of the reel 14 (step S37).

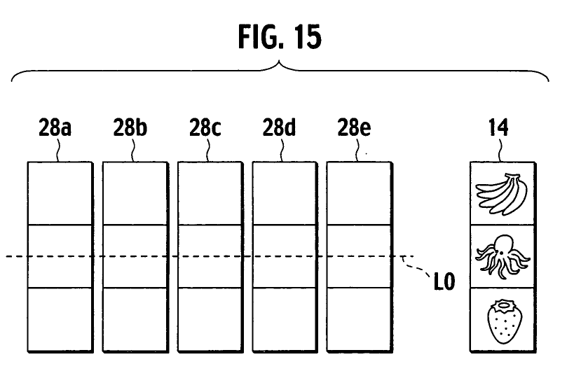

If the main CPU 41 determines that the symbol “OCTOPUS” has come to a stop at the middle level of the reel 14 (YES in step S37) as shown in FIG. 15, the winning combinations all “ORANGE”s and all “BELL”s are shown in FIG. 4 are activated. In other words, the winning combinations all “ORANGE”s and all “BELL”s are newly activated in addition to the initially activated winning combinations all “JACKPOT 7”s, all “BLUE 7”s, all “CHERRY”s and all “PLUM”s as well (step S38).

On the other hand, if it is determined that the symbol “OCTOPUS” has not come to a stop at the middle level of the reel 14 (NO in step S37), the number of the activated winning combinations are not increased and only the initially activated winning combination all “JACKPOT 7”s, all “BLUE 7”s, all “CHERRY”s and all “PLUM”s are provided as activated winning combinations.

Next, the main CPU 41 sequentially stops the symbol being scrolled on each of the display areas 28 (step S39). Subsequently the main CPU 41 determines whether or not symbols which compose the activated winning combination have come to a stop on the payline L (step S40). If it is determined that symbols composing the activated winning combination have come to a stop (YES in step S40), payout is made referring to the payout table shown in FIG. 4 (step S41).

Therefore, for example, when symbols composing a winning combination of “ORANGE”s come to a stop on the payline L shown in FIG. 2, payout is made according to the winning combination, since the winning combination of “ORANGE”s has been activated if the specific symbol “OCTOPUS” has been stopped by the stop control game. In particular, payout of 12 coins per bet occurs.

On the other hand, when the specific symbol “OCTOPUS” has not been stopped on the reel 14 by the stop control game, payout will not be made even if symbols composing the winning combination of “ORANGE”s come to a stop on the payline L, since the winning combination of “ORANGE”s has not been activated. In other words, the possibility of obtaining a larger amount of payout rises if the specific symbol “OCTOPUS” is successfully stopped by the stop control game.

Additionally, in the present embodiment, an example is described in which the stop control game is executed once and two combinations all “ORANGE”s and all “PLUM”s which compose the winning combinations are newly activated if the symbol “OCTOPUS” is successfully stopped. However, the stop control games may be executed multiple times and the number of the winning combinations to be activated may be increased if the specific symbol “OCTOPUS” comes to a stop for a larger number of times.

For example, when a combination of predetermined symbol “LOBSTER”s comes to a stop in step S16 of FIG. 7, the stop control game is executed four times such that the winning combination all “ORANGE”s is activated if the specific symbol “OCTOPUS” comes to a stop once in the four stop control games, and the winning combination all “BELL”s is further activated if the symbol “OCTOPUS” comes to a stop twice in the stop control games. In addition, it may be configured such that the winning combination all “STRAWBERRY”s is further activated if the symbol “OCTOPUS” comes to a stop three times in the stop control games, and if the symbol “OCTOPUS” comes to a stop all times in the four stop control games, the winning combination all “CRAB”s is further activated.

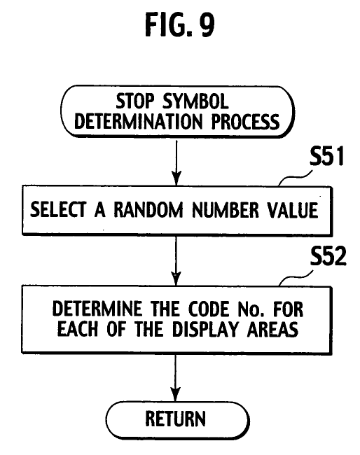

Next, a process for determining the symbols to be stopped which is shown in step S14 of FIG. 7 will be described, referring to the flow chart shown in FIG. 9.

FIG. 9 is a flow chart illustrating the procedure of a process of determining the symbols to be stopped, which is shown in step S14 of FIG. 7. The process is executed by the main CPU 41 executing the stop symbol determination program stored in the RAM 43.

First, the main CPU 41 selects random number values corresponding to each of the columns of the display areas 28 from a numeral range of 0 to 255 by executing a random number generation program included in the stop symbol determination program (step S51).

Next, the main CPU 41 refers to symbol weighting data according to the payout rate setting data which is output from the GAL 54 and stored in the RAM 43 and determines (step S52), based on five random number values selected, code numbers (see FIG. 3) for each of the display areas 28.

The code numbers for each of the display areas 28 correspond to the code numbers of the symbols to be displayed in a stopped state on the middle level of the display areas (payline L). The main CPU 41 determines a winning combination by determining the code number for each of the display areas 28. For example, if the code numbers for each of the display areas 28 are determined as “00”, “00”, “00”, “00”, “00” respectively, the main CPU 41 have determined the winning combination as “JACKPOT 7”.

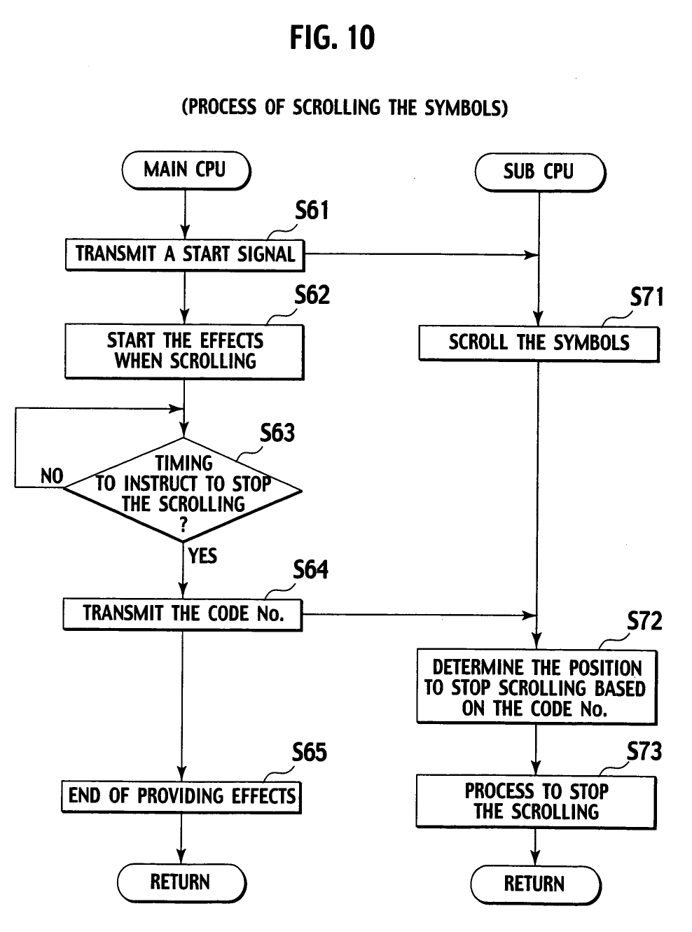

FIG. 10 is a flow chart illustrating the process of scrolling the symbols shown in step S15 of FIG. 7 in. Here, the process is executed between the main CPU 41 and the sub CPU 61.

First, the main CPU 41 transmits, to the sub CPU 61, a start signal to start scroll of symbols on the display areas 28 of the liquid crystal display unit 17 (step S61). Upon accepting the start signal from the main CPU 41, the sub CPU 61 outputs, to the VDP 46, a scroll command of the symbols. The VDP 46 reads image data of the symbols stored in the image data ROM 47, and scrolls the symbols on the five columns of the display areas 28 of the liquid crystal display unit 17 (step S71), whereby scrolling of the symbols is started in each of the five columns of the display areas 28.

After having transmitted the start signal to the sub CPU 61 in step S61 shown in FIG. 10, the main CPU 41 provides effects while the symbols are being scrolled (step S62). The process displays images to the lower display panel 16 or outputs sound from the loudspeaker 29 for a period (e.g., three seconds) defined by the result of determining the symbols to be stopped (step S14 of FIG. 7).

Next, the main CPU 41 determines whether or not it is a proper timing to instruct to stop the scrolling has come (step S63 of FIG. 10).

If, in the process of step S63, it is determined that it is not a proper timing to instruct to stop the scrolling, the process returns to step S63 and continues to provide effects during the scrolling. Otherwise, if, in the process of step S63, it is determined that it is a proper timing to instruct to stop the scrolling, the Main CPU 41 transmits the code number of the symbol stored in the RAM 43 to the sub CPU 61 (step S64). Upon accepting the code number of the symbol from the main CPU 41, the sub CPU 61 determines the position to stop the scrolling in accordance with the code number (step S72).

Subsequently, a process to stop the scrolling is executed, whereby the symbols are displayed in a stopped state (step S73) on each of the display areas 28. In addition, the process of displaying effect images by the main CPU 41 is completed (step S65).

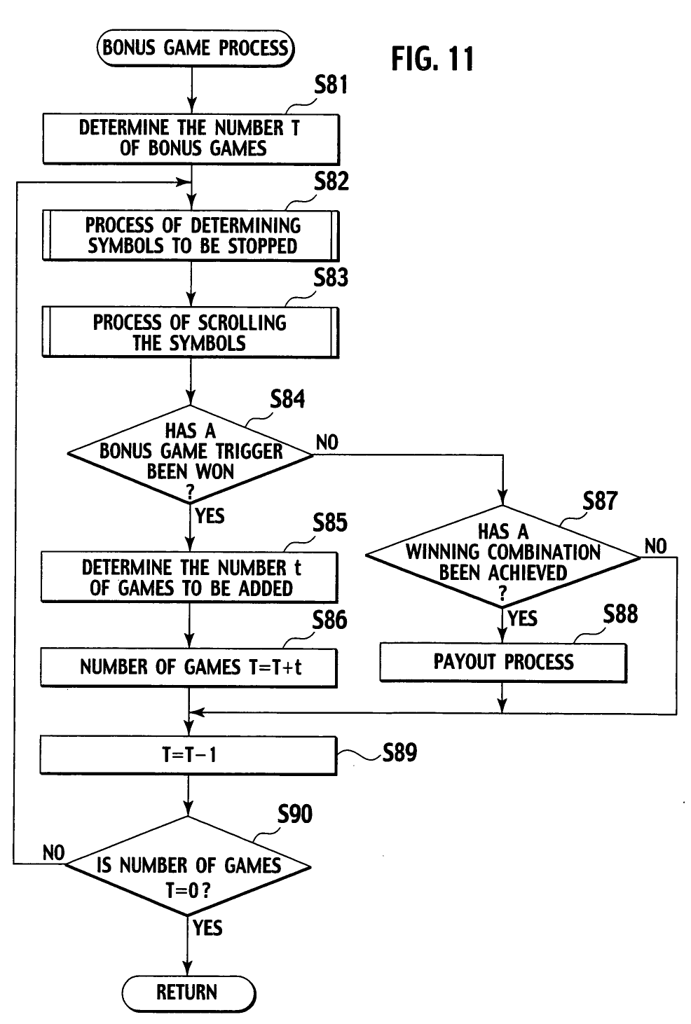

FIG. 11 is a flow chart illustrating the bonus game process shown in step S19 of FIG. 7. In the bonus game process, the main CPU 41 first determines, based on the random number value obtained by executing a random number generation program included in the stop symbol determination program stored in the RAM 43, the number of execution times T of the bonus game from 10 to 25 games (step S81). The main CPU 41 stores, in RAM 43, data of the determined number of games T of the bonus game.

Next, the main CPU 41 executes a process of determining the symbols to be stopped (step S82) and a process of scrolling the symbols (step S83). The process of step S82 is generally similar to the process explained using FIG. 9. Likewise, the process of step S83 is generally similar to the process explained using FIG. 10. Since these processes have already been described, duplicate description will be omitted here.

Next, in FIG. 11, main CPU 41 determines whether or not the bonus trigger has been established, i.e., the combination of “APPLE”s has come to a stop on the payline L on the display areas 28 (step S84). If it is determined that the bonus game trigger has been established (YES in step S84), the number of repetition t of the bonus game is newly determined (step S85). The determined number of repetition t is added to the game number T of the current bonus game (step S86), whereby the remaining number of times of the bonus game increases if the bonus game is won again during execution of the bonus game.

If the bonus game trigger has not been established, the main CPU 41 determines whether or not a winning combination is achieved (step S87). If it is determined that a winning combination has been achieved (YES in step S87), the main CPU 41 executes payout of coins according to the number of coins inserted and the winning combination (step S88). In this event, payout is made based on the payout table shown in FIG. 4.

When the process of step S86 or S88 is executed, or if it is determined in step S87 that none of the winning combination is achieved (determined to be losing), the main CPU 61 reads out the game number T of the bonus game stored in the RAM 43 and subtracts a value 1 from the read-out game number T. Then, the game number T after subtraction is stored in the RAM 43 again (step S89).

Subsequently, the main CPU 41 determines whether or not the game number T of the bonus game has reached the number of times determined in step S81 (step S90). Specifically, the determination is based on whether or not the game number T stored in the RAM 43 has become zero. If the game number T is not zero, in other words, if it is determined that the number of execution times of the bonus game has not reached the number of times determined in step S81, the process returns to step S82 and the above process is repeated.

On the other hand, if the game number T is zero, in other words, if it is determined that the number of execution times of the bonus game has reached the number of times determined in step S81, the process is completed. The bonus game is executed in this manner.

FIG. 12 is an illustration of an exemplary image displayed on the upper display panel 33 and the lower display panel 16 when the stop control game is executed. An arrow pointing upward and an image 92 of characters “LOOK UP!” are displayed at the bottom of the lower display panel 16. The image 92 is for prompting the player to look at the upper display panel 33.

Character strings “PRESS THE BUTTON TO STOP THE REEL” and “PLEASE STOP AT THE “OCTOPUS”” are displayed on the upper display panel 33. Looking at the display, the player can recognize that the spinning reel 14 can be stopped by pressing the stop switch 82.

In this manner, with the slot machine and playing method according to the present embodiment, a stop control game is started when a combination of predetermined symbols such as the “LOBSTER”, for example, has come to a stop along the payline L, wherein the symbols being scrolled on the reel 14 can be stopped by the player's operation of pressing the stop switch 82. Then, the player presses the stop switch 82 to stop the symbols being scrolled on the reel 14, whereby the number of the activated winning combinations is increased when a specific symbol such as the “OCTOPUS”, for example, has come to a stop.

Therefore, a larger number of winning combinations can be activated when a specific symbol comes to a stop in the stop control games than when the specific symbol does not come to a stop while the stop control games are being executed. Therefore, the player will be attracted by the stop control game without losing concern or interest to the game.

Additionally, when the stop control game is executed multiple times, since a larger number of winning combinations is provided for a larger number of times a specific symbol (for example, the “OCTOPUS”) has successfully been stopped in the multiple executions of the stop control game, the player is encouraged to be highly interested in the stop control game.

Furthermore, since the player can obtain a larger amount of payout if the player succeeds in stopping a specific symbol more times while the stop control game is being executed, the game can have room for using technique.

In addition, since the player can be notified, as shown in FIG. 12, that the spinning reel 14 can be stopped by pressing the stop switch 82, while the stop control game is being executed, the player can smoothly play the stop control game.

Although embodiments of a slot machine according to the present invention have been described as above, they are for illustrative purpose only and not intended to limit the present invention in particular, the specific arrangements of respective units may be suitably changed in design. In addition, since the advantages described in the embodiments of the present invention only enumerate the most preferred advantages which rise from the present invention, advantages of the present invention are not limited to those described in the embodiments of the present invention.

What is claimed is:

1. A slot machine comprising:
a display having a display area; and
a controller operable to:
when automatically rearranging a plurality of symbols which have been arranged in the display area,
vary activated winning combinations of the symbols in the display area of the display, if a symbol arranged in another display area which is different from the display area turns out to be a specific symbol at the timing of rearrangement by accepting a control input signal from an external.

2. The slot machine according to claim 1,
wherein the controller is operable to increase the number of activated winning combinations, if the symbol rearranged in the other display area turns out to be the specific symbol.

3. The slot machine according to claim 1,
wherein the controller is operable to:
while rearranging the plurality of symbols in the display area,
(a) execute the operation of rearranging the symbol in the other display area multiple times by accepting the control input signal from an external, and
(b) increase the number of activated winning combinations as the number of times the symbol has been rearranged into the specific symbol among the multiple times of rearrangement becomes larger.

4. A slot machine comprising:
a display having a display area; and
a controller operable to:
in a case such that a symbol arranged in another display area which is different from the display area is allowed to be rearranged by accepting a control input signal from an external during execution of a unit game which automatically rearranges a plurality of symbols arranged in the display area,
vary activated winning combinations of the symbols in the display area of the display, if a symbol rearranged in the other display area by accepting the control input signal turns out to be a specific symbol.

5. The slot machine according to claim 4,
wherein the controller is operable to increase the number of activated winning combinations in the unit game, if the symbol rearranged in the other display area turn out to be the specific symbol.

6. The slot machine according to claim 4,
wherein the controller is operable to:
during execution of the unit game which rearranges the plurality of symbols in the display area
(a) execute an operation of rearranging the symbol in the other display area by accepting the control input signal from an external multiple times and
(b) increase the number of activated winning combinations in the unit game as the number of times the specific symbol has been rearranged among the multiple times of the rearrangement becomes larger.

7. A slot machine comprising:
a display having a display area for arranging a symbol matrix formed by a plurality of columns and a plurality of rows;
an arrangement controller for selecting and determining symbols to be arranged into the symbol matrix from a plurality of types of symbols and executes an arrangement control to stop the scrolling state at the arrangement of the determined symbols in order to rearrange a plurality of symbols which have been arranged in the display area of the display as a new symbol matrix after scrolling the plurality of symbols;
a stop switch operable by a player and connected to the arrangement controller;
a stop switch controller, there are occasions such that a symbol arranged in another display area which is different from the display area may be rearranged during the scrolling for rearrangement into the new symbol matrix in the display area of the display, and in such occasions the stop switch controller activates the stop switch when rearranging the symbol in the other display area, and executes rearrangement of the symbol in the other display area in accordance with the player's input timing of the stop switch; and
a winning combination controller for increasing the number of activated winning combinations if a specific symbol has been rearranged in the other display area, when rearranging the symbol matrix being scrolled in the display area.

8. The slot machine according to claim 7,
wherein the other display area is provided at a location different from that of the display.

9. The slot machine according to claim 7,
wherein the other display area overlaps with the display area of the display.

10. The slot machine according to claim 7,
wherein the winning combination controller notifies the activated winning combinations to the player.

11. A playing method of a slot machine, comprising
causing a controller to vary activated winning combinations of symbols in a display area of a display, when the controller automatically rearranges the plurality of symbols arranged in the display area of the display, if a symbol arranged in another display area which is different from the display area has been rearranged by accepting a control input signal from an external and the rearranged symbol turns out to be a specific symbol.

12. The playing method of the slot machine according to claim 11,
wherein the controller increases the number of activated winning combinations when the symbol rearranged in the other display area turns out to be the specific symbol.

13. The playing method of slot machine according to claim 11,
wherein, during the rearrangement of the plurality of symbols in the display area, rearrangement of the symbol in the other display area by accepting the control input signal from an external is executed multiple times, and the controller increases the number of the activated winning combinations as the number of times the specific symbol has been rearranged among the multiple times of the rearrangement becomes larger.

14. A playing method executed by a slot machine, comprising:
determining a plurality of symbols for rearrangement prior to their rearrangement by a controller to rearrange a combinations of the symbols in a display area of a display when the plurality of symbols have been arranged in the display area of the display to be later rearranged thereon;
in a case in which a symbol arranged in another display area which is different from the display area is allowed to be rearranged until the combination of the symbols arranged in the display area is rearranged, when rearrangement is allowed, activating a stop switch connected to the controller to rearrange the symbol in the other display area by an input from the stop switch, regardless of the control executed by the controller; and
increasing the number of activated winning combinations of the symbols in the display area of the display when the symbol rearranged in the other display area turns out to be a specific symbol.

15. The playing method executed by a slot machine according to claim 14, further comprising
executing an operation of rearranging the symbol in the other display area by an input from the stop switch until the combination of the symbols is rearranged in the display area of the display, wherein the number of the activated winning combinations is increased as the number of times the specific symbol has been rearranged among the multiple times of rearrangement of the symbol becomes larger.

16. A playing method executed by a slot machine, comprising:
repeating a unit game that starts the game by scrolling a plurality of symbols arranged in a display area of a display by the control of a controller, and completes the game by stopping the plurality of symbols at the combination determined by the controller for rearrangement, whereby automatically stopping the scrolled symbols;
scrolling symbols arranged in another display area which is different from the display area until the symbols being scrolled are automatically stopped, and allowing the symbols being scrolled in the other display area to be rearranged based on an input signal from a stop switch connected to the controller;
determining whether or not a symbol rearranged in the other display area has been a specific symbol; and
increasing the number of activated winning combinations of the symbols in the display area of the display when it is determined that the rearranged symbol has been the specific symbol.
